(19) United States
(12) Patent Application Publication
(10) Pub. No.: US 2021/0002078 A1
(43) Pub. Date: Jan. 7, 2021

(54) Systems and Methods for High Throughput Object Handling and Screening

(71) Applicant: Michael William James MacDonald, Bedfordshire (GB)

(72) Inventor: Michael William James MacDonald, Bedfordshire (GB)

(21) Appl. No.: 16/918,857

(22) Filed: Jul. 1, 2020

Related U.S. Application Data
(60) Provisional application No. 62/869,350, filed on Jul. 1, 2019.

(51) Int. Cl. B65G 19/26; B65G 15/44; G01V 1/00; G01V 8/12; G01N 23/10; G01N 23/04; G05B 19/406; G06T 7/70; G06T 7/13

(52) U.S. Cl. CPC B65G 19/265; G06T 2207/30232; G01V 1/00; G01V 8/12; G01N 23/10; G01N 23/04; G05B 19/406; G06T 7/70; G06T 7/13; B65G 2203/044; B65G 2203/042; B65G 2203/0233; G01N 2223/04; G01N 2223/40; G01N 2223/639; G05B 2219/37326; G06T 2207/10116; B65G 15/44

(57) ABSTRACT

Systems and methods described herein are for high throughput object handling and X-Ray screening systems. Material handling systems can adopt the proposed system to assist with the transportation of objects into X-Ray screening machines populated with lead curtains to curtail radiation emissions. The lead curtains associated with X-Ray screening machines can cause numerous problems to the safe and secure transportation of the objects. The systems and methods proposed control several aspects of the object handling to overcome the problems associated with the lead curtains. The system and methods results in the increase of system throughput, improved efficiency, reduction in line stoppages and general wear and tear. Systems can include a smart conveyor that assists objects through lead curtains using flights that are raised behind the trailing edge of the objects. The system can include smart conveyors and control systems that communicate with the X-Ray machine regarding the identity and status of the objects.

### CROSS REFERENCE TO RELATED APPLICATIONS

The present application claims the benefit of U.S. Provisional Patent Application No. 62/869,350, filed on Jul. 1, 2019, which is incorporated herein by reference in its entirety.

### BACKGROUND

Airport facilities, warehouse facilities, and parcel management facilities can receive a high volume of objects such as bags, sealed packages, cargo, and the like, that must be examined, or screened or both. For example, airport facilities require one hundred percent (100%) screening of all hold objects. The screening of objects within an airport facility is also constrained by time pressures. The X-Ray scanner systems used in airport facilities, warehouse facilities and parcel management facilities typically have issues with handling lightweight objects or objects with smaller dimensions or both due to the lead curtains in the X-Ray scanner. Mishandling of the object by the X-Ray scanner systems can result in object being stuck at one of the lead curtains before the entrance to the X-Ray scanner, object being stuck at one of the lead curtains at the exit of the X-Ray scanner, multiple pieces of object being passed through the X-ray scanner at the same time (e.g., stuck object being pushed through the lead curtains and into the X-Ray scanner by heavier object), which can cause the X-Ray scanning system to capture distorted images of the object, or to wrongly identify the object passing through the X-Ray scanner or both. This mishandling of object by the X-Ray scanner system can result in the frequent stopping of the operation of the X-Ray scan system, manual inspection of the object, or delays in processing due to rescreening of the objects or both.

### BRIEF DESCRIPTION OF DRAWINGS

Illustrative embodiments are shown by way of example, in the accompanying drawings and should not be considered as a limitation of the present disclosure.

FIG. 1 illustrates a portion of an object handling system in accordance with various embodiments of the present disclosure.

FIG. 2A illustrates a side view of a portion of an object handling system in accordance with various embodiments of the present disclosure.

FIGS. 2B, 2C, and 2D illustrate a conveyor with flights in accordance with various embodiments described herein.

FIGS. 3A, 3B, 3C, and 3D illustrates a portion of the conveyor including a transfer bar and wear strip in accordance with various embodiments described herein.

FIG. 3E is a schematic diagram that illustrates a guided track under the conveyor that includes a gradual slope and a wear strip that selectively engages with a cam of a flight in accordance with various embodiments described herein.

FIG. 3F illustrates a portion of the conveyor including a plurality of flights in accordance with various embodiments described herein.

FIG. 3G-J illustrate perspective views of the conveyor showing the transfer bar, guide vane, wear strip, and cams in accordance with embodiments of the present disclosure.

FIG. 4 is a block diagram of an example computing system for implementing exemplary embodiments of the present disclosure.

FIG. 5 illustrates a flowchart for a method for handling objects with various embodiments described herein.

### DETAILED DESCRIPTION

Described in detail herein are systems and methods for object handling and screening. For example, the system can be used to transport objects in a controlled manner up to the entrance to an X-Ray machine and in a controlled manner from the exit of an X-Ray machine. Some examples of objects that can be transported by embodiments of the present disclosure can include, for example, objects, luggage, packages, parcels, boxes, crates, any suitable objects or a combination thereof.

The term object is used herein to refer to any item that is transported through the X-Ray machine.

The systems and methods taught herein control several aspects of the object handling and screening and can increase throughput, improve efficiency, reduce or limit wear, reduce line stoppages and reduce the number of lead curtains used to prevent leakage of x-ray radiation. Embodiments of the present disclosure can include a conveyor that assists an object that can have difficulty with a lead curtain used to limit radiation from the X-Ray machines. The weight and number of the lead curtains deployed to prevent leakage of x-ray radiation from the X-Ray machine can also prevent light objects (e.g., packages that weigh 0.5 Kg or less) from passing through the curtains because the light object may not exert sufficient force required to displace the lead curtains (e.g., a friction force between the object and the conveyor may be insufficient to overcome the force exerted on the object by the lead curtain). This can contribute to issues such as the object being withheld in front of the lead curtains, a later object pushing the previous withheld object that is stuck on the lead curtains resulting in a mismatch between an object identity (object-ID) associated with the objects, distorted images when a later object pushes the previous object, and more than one object appears as one object or the contents of the two objects are screened together in the X-Ray machine, and the like. This can result in rescanning of the object, manual inspection of the object and increased system delays due to additional object handling, jamming or damage to the equipment, and the like.

Embodiments of the systems of the present disclosure for handling objects can include a conveyor belt that includes one or more selectively controlled flights or flaps integrated along a belt of the conveyor. The flights can be structural elements such as rotatable flaps that are spaced apart along the length of the belt of the conveyor that include cams that engage a cam surface below the belt to impart a moment on the flight and projections that respond to the moment by rotating from a retracted position to an extended position to aid the movement of an object forward in the conveyor. In some embodiments, flights can serve to separate the belt into bins for holding objects. The flights can be independently and separately controlled on the belt of the conveyor such that only some of the flights on the conveyor are rotated to an extended position and other flights are in the retracted position on the conveyor. In some embodiments, the conveyor may be housed in a tunnel that includes one or more lead curtains to contain X-Ray radiation. The flights can be arranged in rows positioned transverse to the direction of travel of a conveyor belt to form an array of flights along a length of the belt. In a first, default position, the flights can be normally located on the same plane as the conveyor belt or in parallel to the belt. In a second, operational position, the flights can be raised to be positioned perpendicular to the conveyor belt. When engaged perpendicular to the conveyor belt the flights can assist the object through the journey of the conveyor belt. For example, an object such as a parcel package may be stuck on a conveyor belt due to the weight of the object being insufficient to generate a force that can push past an obstacle in the line of travel of the object. Examples of obstacles may include lead curtains in tunnels of X-Ray machines, curvatures in conveyor belts, friction free conveyor belt material offering no grip and the like.

In an embodiment, the flights when engaged can assist the object through lead curtains by forcing the object through the lead curtains and preventing the force from the lead curtains from ceasing the travel of the object or causing the object to slip on the belt. In some embodiments, the conveyor disclosed herein can be part of the X-Ray machine, or integrally formed with an X-Ray machine at the intake and exit of the X-Ray machine or both to assist the objects such that the intake of the X-Ray machine includes an entry conveyor and the exit of the X-Ray machine includes an exit conveyor. In other embodiments, the entry conveyor, or the exit conveyor (collectively conveyor) or both disclosed herein can engage with an existing X-Ray machine and can interface with the intake and exit of the X-Ray machine. For example, an entry conveyor that is separate and distinct from the X-Ray machine can be positioned upstream of the inlet to transfer the object to the X-Ray machine and an exit conveyor that is separate and distinct from the X-Ray machine can be positioned downstream at the exit to transfer the object out of the X-Ray machine.

The object can be transported by the existing conveyor transportation system and can be moved towards the X-Ray machine via the entry conveyor. The preceding conveyor associated with the existing conveyor transportation system and the entry conveyor can include one or more sensors to sense the presence of the object, the leading edge of the object, or the trailing edge of the object, or both. As an example, the one or more sensors can be optical sensors or acoustic sensors, where the optical sensors can emit and corresponding optical detectors can detect optical signals, and the acoustic sensors can emit and acoustic detectors can detect acoustic signals. The one or more sensors can have a reflective configuration in which a signal source and signal receiver are collocated or a transmissive configuration in which the signal source and the signal receiver are opposingly spaced from each other. In some embodiments, in operation, the system can use the one or more sensors to sense the trailing edge of the object and to determine to engage the flights in response to the sensing the trailing edge of the object to assist the object through the lead curtains. In some embodiments, in operation, the system can use the one or more sensors to sense the leading edge of the object and to determine to engage the flights in response to the sensing the leading edge of the object to assist the object through the lead curtains.

Systems and methods described herein can include interfaces to existing X-Ray machines and can engage with the intake and exit rollers, conveyors or both on existing X-Ray machines. In some embodiments, the lead curtains in the tunnel of the X-Ray machine can be removed or eliminated or moved to the conveyors described herein such as the entry conveyor and the exit conveyor which can be positioned at the entry and exit of the X-Ray machine to increase throughput, improve efficiency, reduce or limit wear, and reduce line stoppages. Systems and methods described herein can interface and communicate with the X-Ray machine to transfer information about the object such as an object-ID, receive information about the screened object to identify the objects that can be rejected based on the X-Ray screening process and the like.

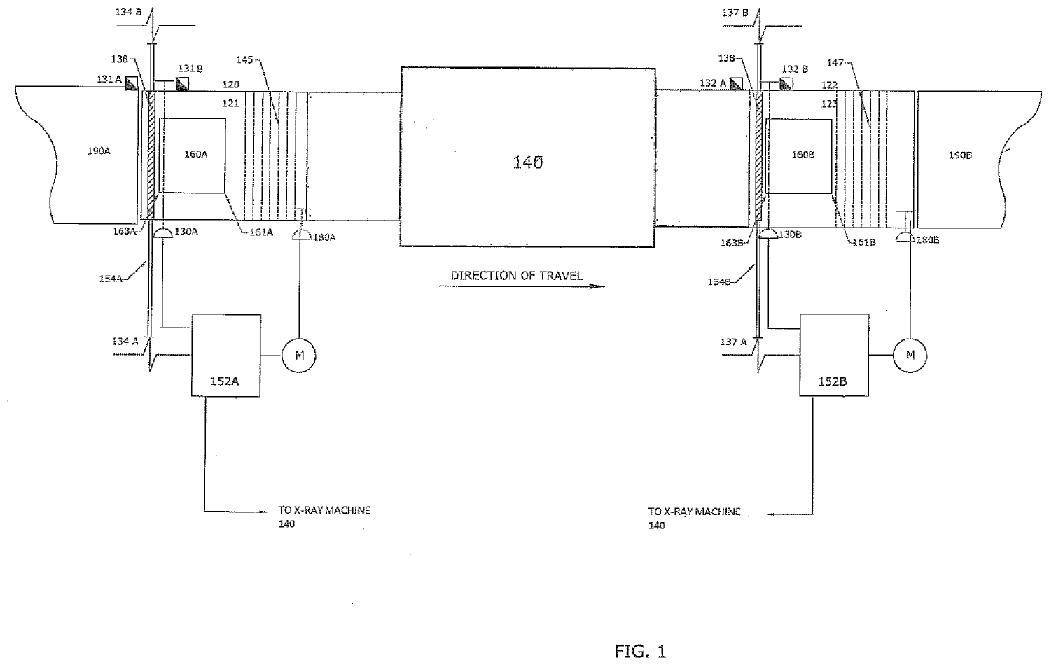

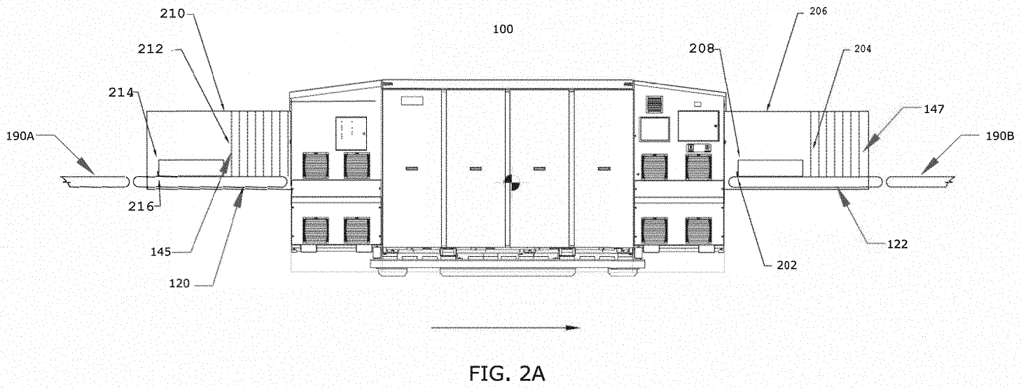

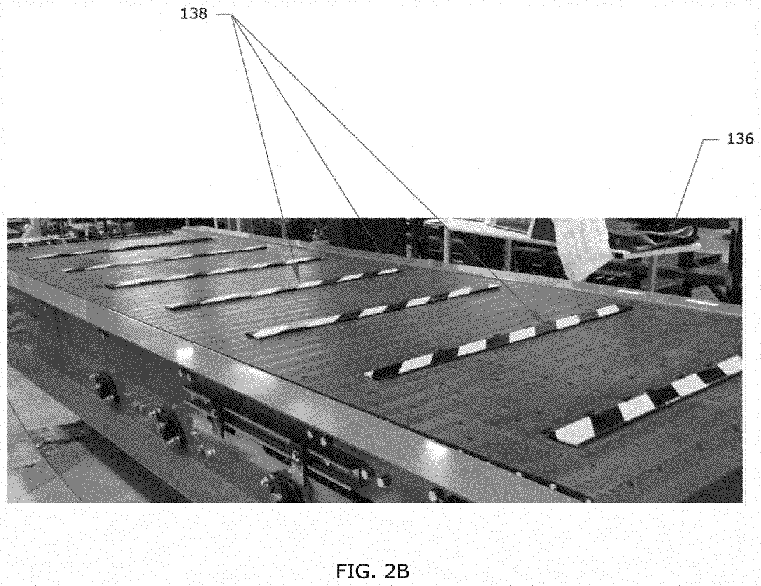

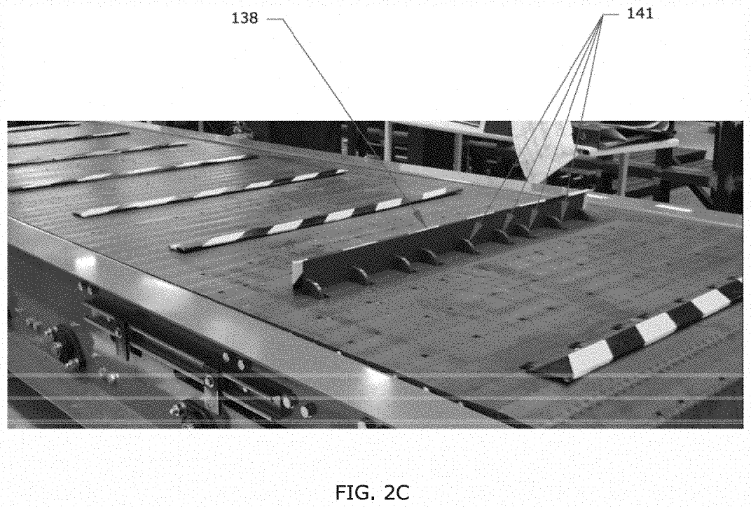

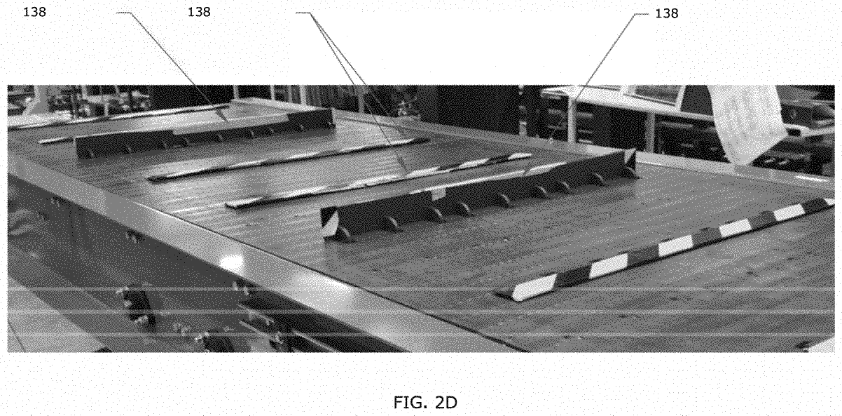

FIG. 1 and FIG. 2A illustrates a smart conveyor system 100 in accordance with various embodiments described herein. The smart conveyor system 100 includes an entry conveyor 120 and an exit conveyor 122 and a computing control system 150. Objects can be received by the entry conveyor 120 from an external material handling system 190A and objects can be output from the exit conveyor 122 to an external material handling system 190B. As shown in FIG. 2A, in some embodiments, the entry conveyor 120 and the exit conveyor 122 can include a housing that forms a tunnel through which objects are transported. The tunnel can be lined with lead and can include or house lead curtains 145, 147. Lead curtains that would have otherwise been in the X-Ray machine 140 can be removed or omitted (e.g., the lead curtains of the X-Ray machine can be relocated to the entry conveyor 120 and the exit conveyors 122). The lead curtains 145 in the entry conveyor 120 can be located away from the entry point of the entry conveyor to provide an intake or platform area for the object which is unencumbered by the presence of any lead curtain restrictions. Likewise, the lead curtains 147 of the exit conveyor 122 can be located away from the entry point of the entry conveyor to provide an intake or platform area for the object that is unencumbered by the presence of any lead curtain restrictions. These clear areas allow the object to transfer seamlessly and further allow the approaching flight to be raised behind the trailing edge 163A of the object 160A, thus assisting the object 160A or 160B in advance of engagement with the lead curtains 145 or 147 respectively. The position of the lead curtains 145 at the rear of the entry conveyor 120 (i.e., proximate to the intake of the X-ray machine) and rear of the exit conveyor 122 enhances the protection against radiation leakage outside of the X-Ray machine by virtue of being further away from the entrance to the X-ray machine and the exit of the X-ray machine (as compared to conventional arrangements in which the lead curtains are disposed within the X-ray machine). The lead curtains 145 are also further away from the entrance to the entry conveyor 120. The smart conveyor system 100 can include a lead lined tunnel extension 206, 210 including relocated heavy duty lead curtains 212, 204. The smart conveyer system 100 can fully assist the object 214 with a raised flight 216 prior to engagement with the lead curtains 212. The smart conveyer system 100 can use the raised flight 216 positioned behind the object to assist transfer of the baggage through the relocated heavy lead curtains 212, 204. Similarly, the smart conveyer system can use the raised flight 202 to fully assist the object 208 with a raised flight 202 prior to engagement with the heavy lead curtains 204.

The entry conveyor 120 can include one or more sensors (entry signal source) 130A for sensing the object 160A. The entry conveyor 120 can also include one or more solenoids to control the raising and lowering of the flights as described herein. Outlined in FIG. 1 is a two solenoid operation, a raise flight solenoid 134A and lower flight solenoid 134B. The raise flight solenoid 134A and the lower flight solenoid 134B may be associated with a flight transfer bar, a mechanism that the solenoids maneuver to actuate the raising and lowering of the flights. The mechanism to raise or lower the flights can include two proximity detector switches 131A and 131B to detect the actual position of the transfer arm at any given time. Positioned at the start of the entry conveyor 120 is one or more optical or acoustic sensors 130A for sensing objects entering the entry conveyor 120. For example, the sensor(s) 130A can be optical signal sources or an acoustic signal sources, and can include a signal receiver(s), which can be an optical signal receiver(s) (e.g., formed by one or more photodiodes) or an electromechanical transducer (e.g., formed by piezoelectric material). In one embodiment, the sensor(s) 130A can be a photoelectric (PEC) sensor or multiple PEC sensors that determine the trailing edge of the object 160A, leading edge of the object 160A or both.

The computing system 150 can use an output of the sensor(s) 130A as an input for determining whether to raise a particular flight on the entry conveyor 120. For example, the computing system 150 can engage the flights in response to the sensing the leading edge or the trailing edge or both of the object 160A to assist the object 160A through the lead curtains. In an example, the computing system 150 may be implemented using a special purpose hardware such as an application specific integrated circuit (ASIC), a programmable logic controller (PLC), a microcontroller or the like. For example, the entry conveyor 120 can include a PLC in a control panel 152A that is in communication with the sensors 130A and the solenoids 134A, 134B to raise the one or more of the flights 138 of the entry conveyor 120 via the solenoids 134A, 134B when a trailing edge of an object is sensed. The PLCs of the entry and exit controllers may also be in communication with other components of the computing system to facilitate communication between the entry conveyor 120 and the X-ray machine. The control panel 152A can include an AC power supply such as a three phase power supply.

The exit conveyor 122 can include one or more sensors (exit signal source) 130B for sensing the object 160B. The exit conveyor 122 can also include one or more solenoids 137A/137B to control the raising and the lowering of the flights as described herein. Outlined in FIG. 1 are a two solenoid operation, a raise flight solenoid 137A, and lower flight solenoid 137B. The raise flight solenoid 137A and the lower flight solenoid 137B may be associated with a flight transfer bar, a mechanism that the solenoids maneuver to actuate the raising and lowering of the flights. The mechanism to raise or lower the flights can include two proximity detector switches 132A and 132B to detect the actual position of the transfer arm at any given time. Positioned at the start of the exit conveyor 122 is one or more optical or acoustic sensors 130B for sensing objects entering the exit conveyor 122. For example, the sensor(s) 130B can be optical signal sources or an acoustic signal sources and can include signal receivers, which can be an optical signal receiver (e.g., formed by one or more photodiodes) or an electromechanical transducer (e.g., formed by piezoelectric material). In one embodiment, the sensor(s) 130B can be a photoelectric (PEC) sensors or multiple PEC sensors that determine the trailing edge of the object 160B, leading edge of the object 160B or both.

The computing system 150 can use an output of the sensor(s) 130B as an input for determining whether to raise a particular flight on the exit conveyor 122. In an example, the computing system 150 may be implemented using a special purpose hardware such as an application specific integrated circuit (ASIC), a programmable logic controller (PLC), a microcontroller or the like. For example, the exit conveyor 122 can include a PLC in a control panel 152B that is in communication with the sensors 130B and the solenoids 137A, 137B to raise the one or more of the flights 138 of the exit conveyor 122 via the solenoids 137A, 137B when a trailing edge of an object is sensed. The PLC of the exit controller may also be in communication with other components of the computing system remote from the exit conveyor 122 to facilitate communication between the exit conveyor 122 and the X-ray machine.

As described herein, the computing system 150 can sense the object 160A, a leading edge 161A of the object 160A, or a trailing edge 163A of the object 160A based on an operation of the sensors (e.g., whether or not the sensors sense the presence or absence of the object 160A). For example, for embodiments where the sensors have a transmissive configuration, sensing a break in the signal (e.g., the object 160A blocks the signal of the sensor), the computing system 150 can sense the object 160A. The transition between the sensed absence and presence of the signal by the sensors can be used to identify the leading edge 161A of the object 160A and the trailing edge 163A of the object 160A. For example, the computing system 150 can sense the leading edge 161A of the object 160A on the conveyor belt at a specific location on the conveyor belt when the computing system 150 senses (at the sensors) a change in the output of the sensors indicative of a transition from not sensing the object 160A to sensing the object 160A. The computing system 150 can sense the trailing edge 163A of the object 160A on the conveyor belt at the specific location on the conveyor belt when the computing system 150 senses (at the sensors) a change in the output of the sensors indicative of a transition from sensing the object 160A to not sensing the object 160A after the leading edge 161A is sensed.

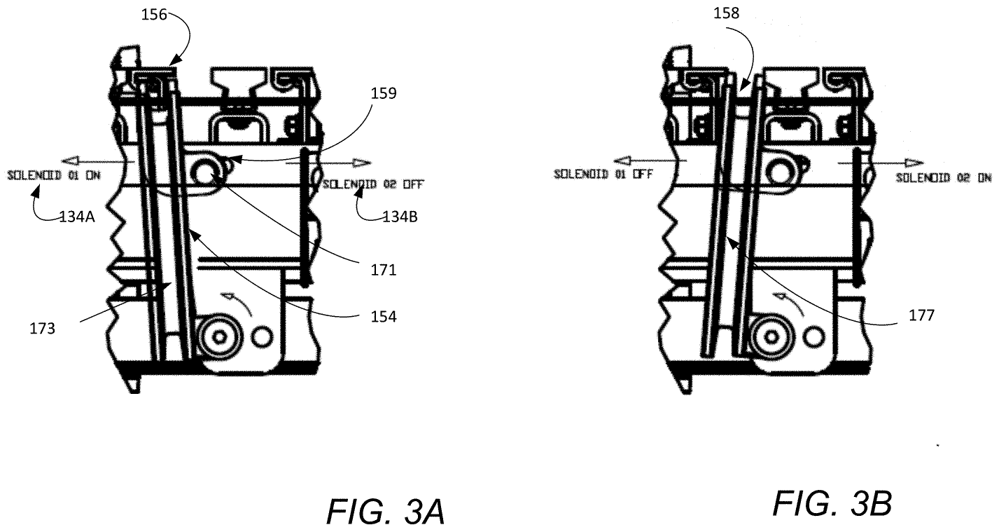

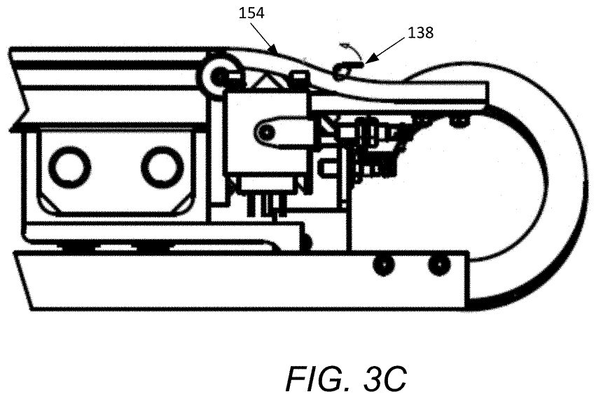

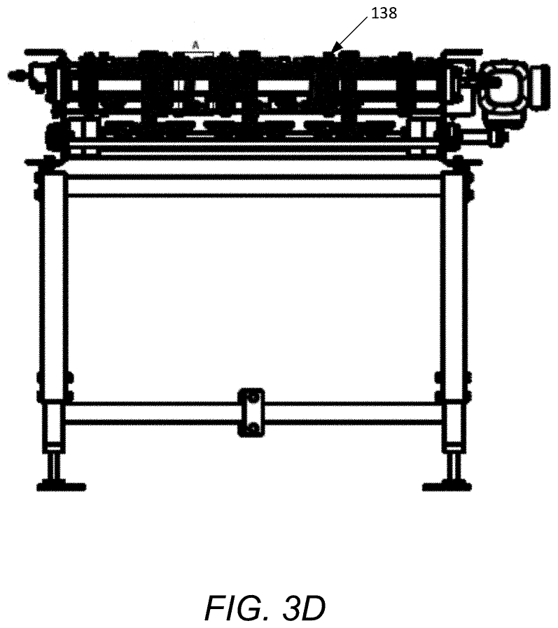

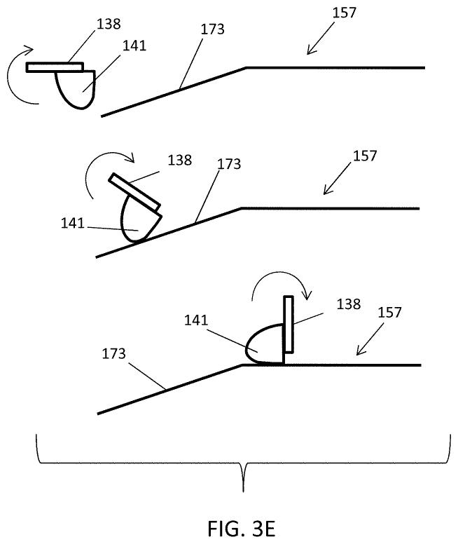

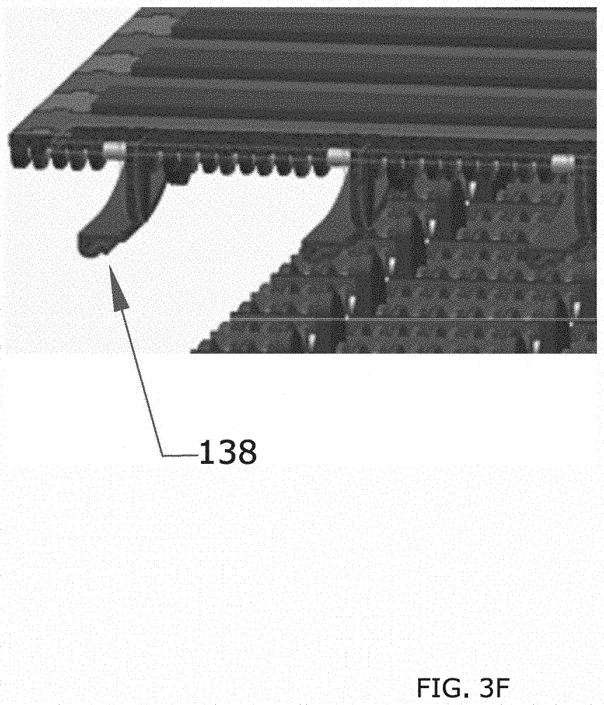

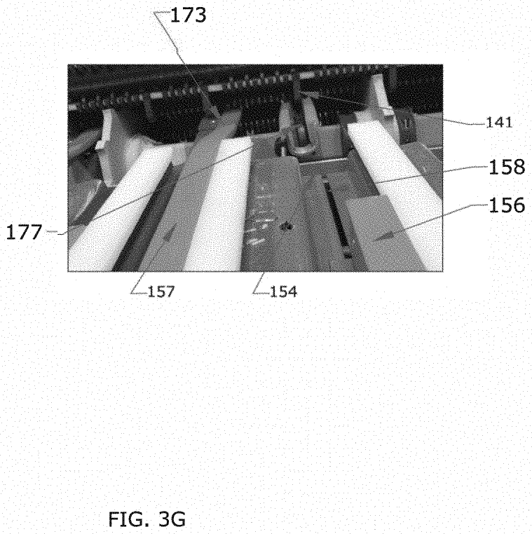

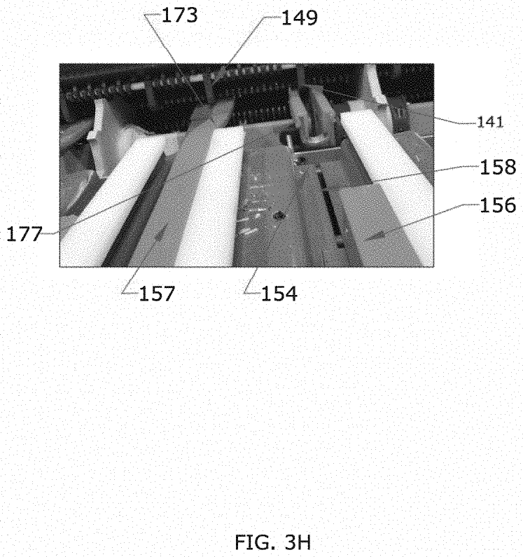

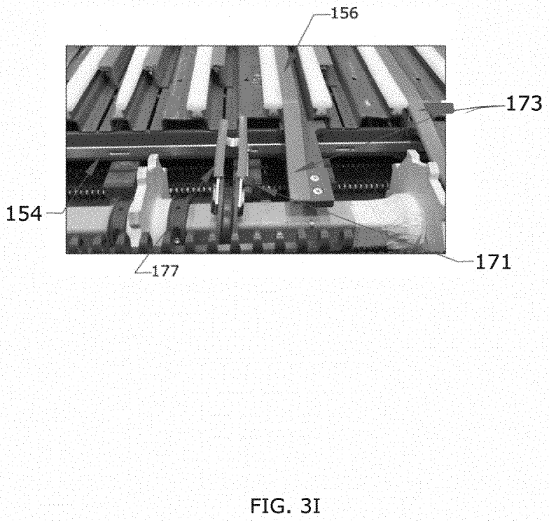

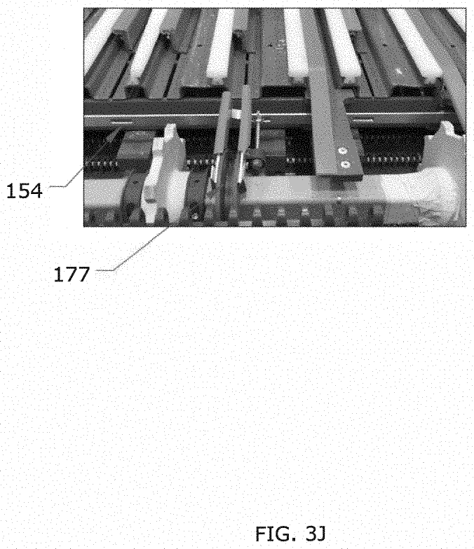

The entry conveyor 120 and the exit conveyor 122 can each include a first conveyor belt 121 and a second conveyor belt 123, respectively, each driven by a motor M, and can each include flights or flaps 138 (flights or flaps are used interchangeably herein). In one example embodiment, the flight 138 can have an elongated, planar body with a rectangular perimeter. FIGS. 1 and 2A, shows the different views of the entry conveyor 120 and exit conveyor 122. As shown in FIGS. 2A, 2B, 2C, and 2D the entry conveyor belt 121, or the exit conveyor belt 123 or both on the entry conveyor 120 and the exit conveyor 122, respectively, can include the flights 138. The flights 138 can have cams 141. FIG. 2B shows the flights 138 in their default or normal position in which the flights 138 are on the same plane as the entry conveyor belt 121 or the exit conveyor belt 123 or both, or parallel to the plane of the smart conveyor. In the default or normal position, the flights 138 can rest against the entry conveyor belt 121 or the exit conveyor belt 123, or both due to gravity when they are on the load bearing portion of the conveyor (i.e., when they are positioned on the side of the conveyor that is moving the object 160A) and as the entry conveyor belt 121 is driven forward by motors of the smart conveyor. FIG. 2B and FIG. 2C shows the flights 138 with the cams 141. The cams 141 can include a rolling or curved edge and two edges that are substantially linear and perpendicular to each other resembling one segment of a circular pie cut into four pieces (e.g., a quarter of a circle). One of the substantially perpendicular edges is attached to the flight 138 and the other substantially perpendicular edge can engage with wear strip 156 to raise the flight or can travel adjacent to the wear strip 156 to remain in the default, normal position as described herein. In an example, the conveyor may include a wear strip 156. In some embodiments, there may be one or more wear strips, e.g., shown as wear strip 156 and wear strip 157 in FIG. 3G described herein. In an embodiment, the flights 138 can be separated by a pitch size (distance between two adjacent flights) to target the object 160A, or the object 160B or both with dimensions that can result in the object 160A or the object 160B or both being stopped by the plurality of lead curtains 145, 147. For example, the pitch size can be 50 mm for use in airport object scanners for a specific weight of the plurality of lead curtains 145,147 used on the entry conveyor 120, or the exit conveyor 122 or both. In airports, the object 160A, 160B may be presented at a 100 mm gap to ensure the integrity of the X-Ray image and to differentiate one object from the next object.

Referring to FIGS. 2A, 2B, 2C and 2D, the entry conveyor 120 and the exit conveyor 122 can include the lead curtains 145,147, respectively. The lead curtains 145 on the entry conveyor 120 can be located near the existing entry conveyor, entry roller or both of the X-Ray machine 140. Similarly, the lead curtains 147 on the exit conveyor 122 can be located at the distal end of the exit conveyor 122 away from the exit existing conveyor, existing roller or both of the X-Ray machine 140. The X-Ray machine 140 can emit harmful radiation via the entry and exit apertures where the objects are entering and exiting. To limit the exposure to personnel in the immediate area, the entry conveyor 120 and the exit conveyor 122 includes the lead curtains 145,147 as a mechanism to curtail and reduce the X-Ray radiation emissions from leaking out to the area surrounding the X-Ray machine 140 via the entry and exit apertures.

In operation, during a continuous object scanning process, objects can be simultaneously entering the machine, processed by the X-Ray machine 140 within the machine, and exiting the machine. In this scenario, a single lead curtain at the entry to the machine and a single lead curtain at the exit of the machine can invariably be in the raised position when three (3) or more objects are in the X-Ray machine 140 at the same time. Having more than one lead curtain minimizes the leaked radiation.

Referring now to FIGS. 3A-J, the first solenoid 134A can be engaged with a transfer bar 154 (shown in FIG. 3I and FIG. 3J) that runs perpendicular to the direction of travel of the entry conveyor belt 121, or the exit conveyor belt 123 or both. The transfer bar 154 can include a translating gear (FIG. 3A and FIG. 3I show one translating gear 171). In an embodiment, the translating gear 171 can engage a transfer bar 154 to an engaged position with a wear strip 156. The engaged position or flight raise position of the transfer bar 154 is shown in FIG. 3J and FIG. 3H. The normal position of the transfer bar 154 is shown in FIG. 3G and FIG. 3I.

In the normal position of the transfer bar 154, the at least one cam 141 is guided by a guide vane or diverter 177 shown in FIG. 3G towards a channel 158 adjacent to the wear strip 156. In the engaged position of the transfer bar 154, the at least one cam 141 is guided by a guide vane 177 onto a wear strip 156. In some embodiments, the guide vane 177 may translate the at least one cam 141 which translates the flight attached to the at least one cam 141 laterally perpendicular to the direction of travel of the conveyor belt and in turn translates all of the other cams 141. The other cam 149, as shown in FIG. 3H may be guided onto a graded track 173 that can have a gentle slope on a second wear strip 157. The graded track 173 the wear strip 157 can have an angle of approximately five (5) degrees to approximately fifteen (15) degrees or can have an angle of approximate eleven (11) degrees relative to the flat linear portion of the wear strip 156 (e.g., relative to horizontal). The second wear strip 157 may allow the other cam 149 to rise up the gentle slope translating the flight towards the raised position while simultaneously rolling the other cam 141, which in turn rolls the flight perpendicular to the conveyor belt. The cams (e.g., cams 141 and 149) can be operatively coupled to the flight 138 such that when at least one of the cams engages a gently sloping portion of the wear strip, the remaining cams and the flight rotate in unison from the default normal position to the raised position.

As shown in FIGS. 3G and 3H, the wear strip 156 may be located with a gap between the guide vane 177 and the wear strip 156 to allow the cam 141 to engage with the wear strip 156 after the flight has been rotated to the raised position to reduce friction and noise.

The guide vane 177 can engage with at least the cam 141 on one of the flights of the one or more flights 138 to raise the flight behind the trailing edge 163A or 163B of the object 160A or 160B respectively perpendicular to the surface of the entry conveyor belt 121 and the exit conveyor belt 123 in response to sensing the trailing edge 163A or 163B.

The raised flight can be locked into the raised (operational) position by the interaction between the cams and the wear strips so that the flight can push or urge the object 160A or 160B through the lead curtains 145, 147 on the entry conveyor 120 and the exit conveyor 122. The raised flight can push light objects, which can otherwise be arrested against the curtains at the entrance without being able to pass through the lead curtains. Similarly, the raised flight can push light roll type objects, which can otherwise end up rolling continuously at the front of the lead curtains 145, 147, through the lead curtains 145, 147. The raised flight can prevent distorted images being developed within the X-Ray machine by preventing light objects from being pushed through the X-Ray machine 140 by a larger object, heavier object or a heavy and large object. The raised flight can prevent tracking system errors by preserving the order of the objects that are sent through the X-Ray machine. For example, the raised flight can prevent a heavier follow-on object from passing a light object stuck against the lead curtains by ensuring the light object does not get stuck and is pushed through the lead curtains 145, 147. The raised flight can prevent time-out system faults by preventing light objects from being stuck on the plurality of lead curtains 145, 147. The raised flight reduces rescreening due to the reduction in light objects that are stuck at the plurality of lead curtains 145, 147.

The first solenoid 134A can operate to translate the transfer bar 154, which in turn actuates a guide vane 177 between a default retracted position (shown in FIG. 3B) and an engaged raised position (shown in FIG. 3A and FIG. 3C). In an embodiment, the transfer rod 159 actuates the transfer bar at the predefined location on the entry conveyor belt 121, or the exit conveyor belt 123, or both. When the transfer bar 154 is in the default position as shown in FIG. 3B, one of the cams 141 of one of the flights 138 passes the guide vane 177 without rotation of the flights (i.e., the flights remain in their default normal position). When the transfer bar 159 is in the default position the channel 158 allows one or more of the cams 141 under the flight to pass through the channel 158 along a length of the conveyor. When the transfer bar 154 is in the engaged position, as shown in FIG. 3A, the guide vane 177 aligns with the wear strip 156. When aligned, at least one of the cams of one of the flights 138 can roll over a guide vane 177 onto the gentle slope of the graded track 173 of the wear strip 157. In an example, the circular or curved edge of the cam may engage with the gentle slope of the graded track 173. Then at least one cam can rotate the flight until it reaches a position substantially perpendicular to the conveyor belt (i.e., the raised operational position). Then at least one cam may have a flat end that rests on top of the wear strip 156. Then at least one cam when engaged with the wear strip 156, can hold or lock the flight in place based on the friction or support between the at least one cam and the wear strip 156. The flight can be raised behind the trailing edge 163A,163B of the object 160A,160B (in response to sensing the trailing edge) to assist the object 160A,160B through the lead curtains on the entry conveyor belt 121, or the exit conveyor belt 123 or both. At the end of the entry conveyor 120 or the exit conveyor 122 or both, the wear strip 156 ends and is no longer available, the conveyor belt rolls under the exit conveyor 120, or the exit conveyor 122 or both. As a result, the raised flight disengages the wear strip, providing a gravity release of the raised flights allowing the raised flights to return to the default, normal position (FIG. 3F shows one of the flights 138 under the conveyor belt after gravity release). In an example, the wear strip 156 may engage a mild slope at the other end of the conveyor to allow at least one cam to roll off the wear strip 156 gently.

In some embodiments, there can be a second solenoid to actuate the transfer bar 154 to the engaged position, the first solenoid 134A and the second solenoid 134B can operate in concert, where the first solenoid 134A can be turned on and the second solenoid 134B can be turned off. Similarly, to actuate the transfer bar 154 to the disengaged position the solenoids can work in concert, where the first solenoid 134A can be turned off and the second solenoid 134B can be turned on. In an example, the second solenoid 134A may be used as a failsafe during power failure to keep the transfer rod engaged or disengaged as the case may be. In some embodiments, the first solenoid 134A and the second solenoid 134B may be located on the same side of the conveyor belt or may be located on opposite sides of the conveyor belt.

Similarly, in the exit conveyor 122, there can be a second solenoid to actuate the transfer bar 154 to the engaged position, the first solenoid 137A and the second solenoid 137B can operate in concert, where the first solenoid 137A can be turned on and the second solenoid 137B can be turned off. Similarly, to actuate the transfer bar 154 to the disengaged position the solenoids can work in concert, where the first solenoid 137A can be turned off and the second solenoid 137B can be turned on. In an example, the second solenoid 137A may be used as a failsafe during power failure to keep the transfer rod engaged or disengaged as the case may be. In some embodiments, the first solenoid 137A and the second solenoid 137B can be located on the same side of the conveyor belt or can be located on opposite sides of the conveyor belt.

Referring to FIG. 1, the entry conveyor belt 120 and the exit conveyor belt 122 can include one or more flights 138 as shown in FIG. 2B. Each of the one or more flights 138 may be configured to be selectively raised. FIG. 2C shows one of the flights 138 raised perpendicular to the direction of travel of the conveyor belt. FIG. 2C also shows one or more cams 141 that are attached to or integrally formed with the flight. Referring back to FIG. 1, the entry conveyor belt 121 and the exit conveyor belt 122 can include one or more sensors for sensing a trailing edge 163A, 163B of the object 160A, 160B on the conveyor belt, wherein the flight is selectively raised on the conveyor belt behind the trailing edge 163A, 163B of the object 160A, 160B to assist the object forward in the event that the size, or weight or both of the object is insufficient to pass the lead curtains.

The conveyor, as shown in FIG. 3G may include the wear strip 156 under the conveyor belt. In some embodiments, the conveyor, as shown in FIG. 3G may include another wear strip 157 with the gentle slope of the graded track 173. At least one cam in the plurality of cams on a flight may engage with the wear strip 156 under the conveyor belt when the flight is raised perpendicular to the conveyor belt. In some embodiments, the other cam 149, as shown in FIG. 3H may be engaged with the second wear strip 157. In an embodiment, the guide vane 177 (shown in FIG. 3H) of the transfer bar 154 (shown in FIGS. 3A and 3B) may engage with at least one cam of the plurality of cams 141 to translate the flight vertically perpendicular to the direction of travel of the conveyor belt. The perpendicular translation of the flight may translate the other cam 149 to engage with the gentle slope of the graded track 173 of the second wear strip 157. The other cam 149 may rotate as it moves along the second wear strip 157 raising the flight perpendicular to the conveyor belt.

As shown in FIGS. 3A, 3B, 3I and 3J, a transfer bar 154 may be positioned laterally perpendicular to the direction of travel of the conveyor belt and may be located below the conveyor belt. The transfer bar 154 may be engaged with a first solenoid 134A and a second solenoid 134B (as shown in FIGS. 3A and 3B). The transfer bar 154A, 154B translates a transfer rod 159 (as shown in FIGS. 3A and 3B) between an engaged position (as shown in FIG. 3A) and a disengaged position (as shown in FIG. 3B). The transfer rod 159 may include the guide vane or diverter 177, as shown in FIG. 3G. The guide vane 177 may translate the cam 141 and the flight attached to the cam 141 perpendicular to the direction of travel of the conveyor belt to move the other cam 149 (as shown in FIG. 3H). The other cam 149 in the disengaged position may travel on a channel adjacent to the wear strip 157 (as shown in FIG. 3G). In the engaged position the other cam 149 may be guided by the gentle slope of the graded track 173 of the wear strip 157. The other cam 149 can rotate on the wear strip 157 and in turn rotate the flight until another cam 149 rests flat on the wear strip 157, and the flight is positioned vertically perpendicular to the conveyor belt. In an example, the conveyor may include a plurality of channels as shown in FIG. 3I and FIG. 3J to allow the cams of the flights to travel unhindered when the flight is not selectively raised. The transfer rod 159 may translate the transfer bar 154 between an engaged position and a disengaged position to align at least one cam on the flight with the wear strip 156 when the transfer arm is in the engaged position or to align the at least one cam with a channel 158 running along the length of the conveyor belt in the direction of travel of the conveyor belt when the transfer rod is in the disengaged position.

FIG. 3E illustrates a graded track 173 that can include a gradual slope and the wear strip 157. The computing system 150, upon sensing the trailing edge 163A of the object 160A via, e.g., the sensor 130A or 130B, activates a solenoid to move a transfer bar that in turn translates a transfer rod 159. A transfer gear can include guide vane 177. The transfer rod 159 can cause the guide vane 177 to align with a wear strip 157 positioned under the entry conveyor belt 121 or exit conveyor belt 123 to slide at least one of the cams 141 onto the graded track that rotates the cam 141, which causes the flight 138 perpendicular to the surface of the conveyor belt behind the trailing edge 163A of the object 160A.

In an example, the guide vane 177 (e.g., shown in FIGS. 3G-J) may align with the wear strip 157 positioned under the entry conveyor belt 121 to allow one or more of a plurality of cams on one or more of the plurality of flights to slide on the graded track 173 that includes the gradual slope and the wear strip 156. The sliding of the flights 138 on the graded track has the effect of rotating the flight 138 perpendicular to the surface of the conveyor belt behind the trailing edge 163A of the object 160A.

The cam 149 of the flight 138 may then engage with the gentle slope of the graded track 173 and may frictionally rotate as the conveyor belt moves forward. This frictional action, as shown in FIG. 3G, rotates the flight 138 clockwise until a flat end of the cam 141 rests on the wear strip 156. The flat end of the cam 141 continues to rest frictionally on the wear strip 156 as the conveyor belt moves forward.

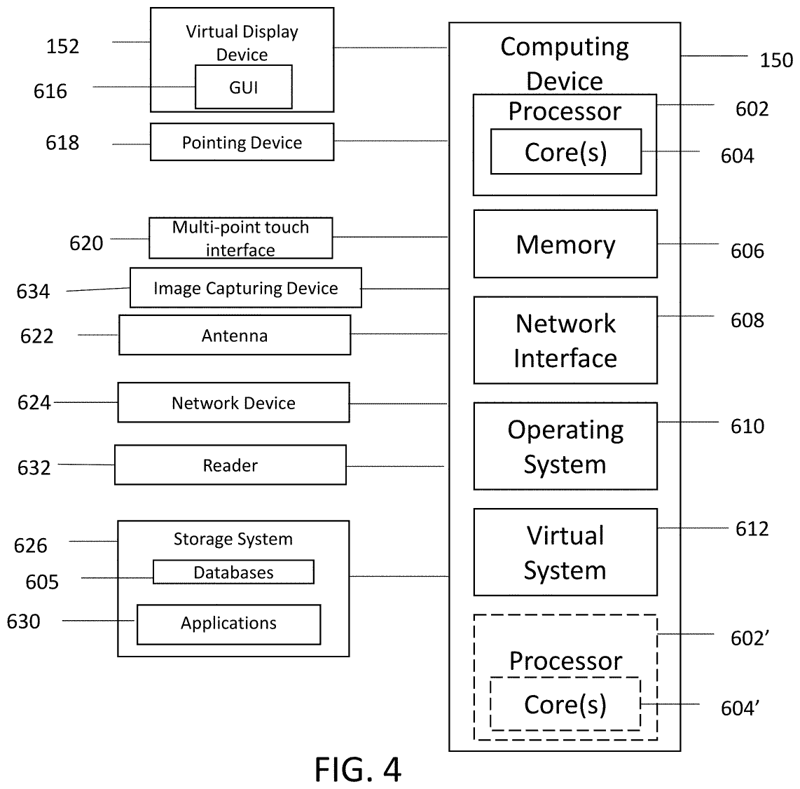

FIG. 4 is a block diagram of an example computing control system 150 for implementing exemplary embodiments of the present disclosure. In various embodiments, the computing system 150 can be integrated into a single unit or can include distributed components that are connected by a network. For example, the computing system 150 can include one or more processors provided as part of the entry conveyor 120, the exit conveyor 122 and a separate processor or processors provided as part of the system. The computing system 150 includes one or more non-transitory computer-readable media for storing one or more computer-executable instructions or software for implementing exemplary embodiments. The non-transitory computer-readable media can include but are not limited to, one or more types of hardware memory, non-transitory tangible media (for example, one or more magnetic storage disks, one or more optical disks, one or more flash drives, one or more solid state disks), and the like. For example, memory 606 included in the computing system 150 can store computer-readable and computer-executable instructions or software (e.g., applications 630) for implementing exemplary operations of the computing system 150 such as, for example, for sensing the trailing edge 163A, 163B of an object and controlling a solenoid to transition a flap behind the trailing edge 163A, 163B from its default normal position to its raised operation position. The computing system 150 also includes configurable processor 602, or programmable processor 602 or both and associated core(s) 604, and optionally, one or more additional configurable, processor(s) 602′, or programmable processor(s) 602′ or both and associated core(s) 604′ (for example, in the case of computer systems having multiple processors, or cores or both), for executing computer-readable and computer-executable instructions or software stored in the memory 606 and other programs for implementing exemplary embodiments of the present disclosure. Processor 602 and processor(s) 602′ can each be a single core processor or multiple core (604 and 604′) processor. Either or both of processor 602 and processor(s) 602′ can be configured to execute one or more of the instructions described in connection with the computing system 150.

Virtualization can be employed in the computing system 150 so that infrastructure and resources in the computing system 150 can be shared dynamically. A virtual machine 612 can be provided to handle a process running on multiple processors so that the process appears to be using only one computing resource rather than multiple computing resources. Multiple virtual machines can also be used with one processor.

Memory 606 can include a computer system memory or random access memory, such as DRAM, SRAM, EDO RAM, and the like. Memory 606 can include other types of memory as well, or combinations thereof.

A user can interact with the computing system 150 through a visual display device 152, such as a computer monitor, which can display one or more graphical user interfaces 616. The user can interact with the computing system 150 using a multi-point touch interface 620, a pointing device 618, an image capturing device 634, or a reader 632.

The computing system 150 can also include one or more computer storage devices 626, such as a hard-drive, CD-ROM, or other computer readable media, for storing data and computer-readable instructions or software that implement exemplary embodiments of the present disclosure (e.g., applications). For example, exemplary storage device 626 can include one or more databases 605 for storing object information or physical parameters related to elements of the system. The databases 605 can be updated manually or automatically at any suitable time to add, delete, update, or a combination thereof, one or more data items in the databases.

The computing system 150 can include a network interface 608 configured to interface via one or more network devices 624 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 622 to facilitate wireless communication (e.g., via the network interface) between the computing system 150 and a network or between the computing system 150 and other computing systems or both. The network interface 608 can include a built-in network adapter, network interface card, PCMCIA network card, card bus network adapter, wireless network adapter, USB network adapter, modem or any other device suitable for interfacing the computing system 150 to any type of network capable of communication and performing the operations described herein.

The computing system 150 can run any operating system 610, such as versions of the Microsoft® Windows® operating systems, different releases of the Unix® and Linux® operating systems, versions of the MacOS® for Macintosh computers, embedded operating systems, real-time operating systems, open source operating systems, proprietary operating systems, or any other operating system capable of running on the computing system 150 and performing the operations described herein. In exemplary embodiments, the operating system 610 can be run in native mode or emulated mode. In an exemplary embodiment, the operating system 610 can be run on one or more cloud machine instances. In some embodiments, the computing system 150 can be implemented as one or more programmable logic controllers (PLCs).

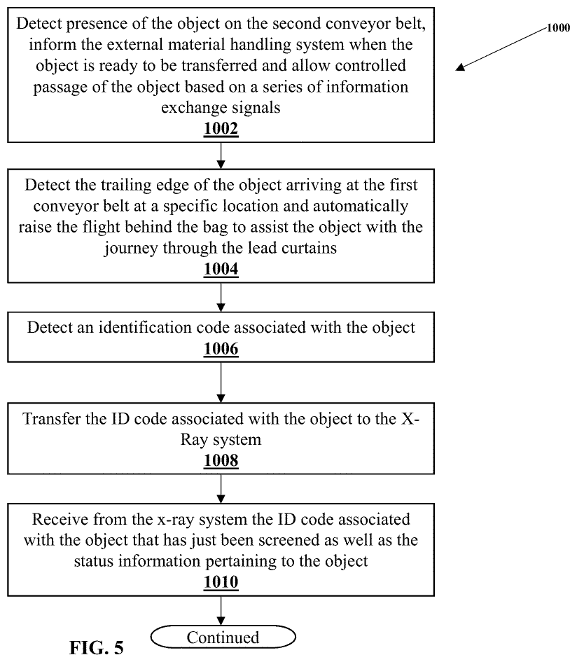

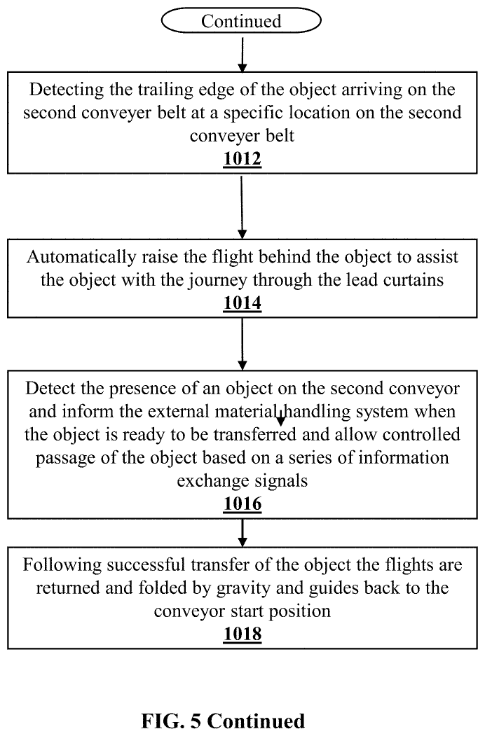

FIG. 5 illustrates a flowchart for a method 1000 for handling objects in accordance with various embodiments described herein. The method 1000 can include one or more machine-readable instructions executed by a processor in the computing system 150. The method 1000 includes sensing the trailing edge 163 of the object 160A arriving on the entry conveyor belt 121 at a specific location on the entry conveyor belt 121 by one or more sensors at step 1002. The computing system 150 can include instructions to sense the trailing edge 163A of the object 160A based on the output of the one or more sensors. The computing system 150 can determine the trailing edge 163A of the object 160A based on the output of the one or more sensors being indicative of a transition from sensing an object to not sensing an object.

At step 1002, the smart conveyor system 100 senses the presence of an object from the preceding Material handling system, which is requesting entry to the smart conveyor system. This transfer of the object from the preceding conveyor system 190A (shown in FIG. 1) is undertaken via a series of volt free contact signals or in some embodiments via a communication protocol that could involve cabling or wireless communications. Information from the smart conveyor system to the Material Handling system can include System Healthy, System running and Space available for entry signals. Information from the Material Handling System to the smart conveyor system can consist of; System Healthy, System running, and object available for entry signals.

At step 1004, the first raise flight solenoid 134A is activated to translate a transfer rod 159 that actuates a transfer bar 154 causing at least one cam of a flight in the flights 138 to be raised behind the trailing edge 163A of the object 160A as described herein. The computing system 150 can include instructions to activate the first solenoid 134A to translate the transfer bar 154A laterally substantially perpendicular to the direction of travel of the entry conveyor belt 121. The transfer bar 154 can engage with the transfer rod 159 and move between a default position or flight lower position and an engaged position or flight raise position. In the engaged position the transfer bar 154 can guide the cam of the flight through a guide vane 177 onto the gentle slope of the graded track 173 of the wear strip 156. The cam 149 underneath the flight rolls over the gentle slope of the graded track 173 until it reaches the top of the slope where it is fully supported in the raised position by the wear strip 157. In the default position, the cam of the flight does not engage with the slope of the graded track 173 and wear strip 157 and instead passes through the channels 158 adjacent to the wear strip 157 and wear strip 156.

At step 1006, an object-ID associated with the object 160A can be sensed. The computing system 150 can use sensors (optical readers, RFID readers, or any other suitable readers) to read a machine-readable ID on the object 160A to identify the object 160A. The computing system 150 can include instructions to sense an object-ID using a sensor located on the entry conveyor 120. In an example, the object-ID can be a machine-readable ID, such as barcodes, RFID tags, Bluetooth LE™ chips, and the like. In some embodiments, the ID associated with object 160A can be communicated directly from the material handling system that controls the delivery of the object 160A to conveyor 121 to the X-Ray System.

At step 1008, the object-ID associated with the object 160A is communicated to the X-Ray machine 140. The computing system 150 can interface with the X-Ray machine 140 to share the ID associated with the object 160A with the X-Ray machine 140. For example, the computing system 150 can, after or before the object 160A has been transferred to the X-Ray machine 140 communicate the object-ID associated with the object 160A. In some embodiments, this object-ID communication is carried out directly from the material handling system to the X-Ray system.

At step 1010, the object-ID associated with the object 160A can be received and an indication of whether the object 160A has passed inspection before or after the object 160A/B (the object 160A when shown on the exit conveyor 122 is called object 160B is transferred onto the exit conveyor 122 can be generated. The computing system 150 can include instructions to receive the object-ID associated with the object 160B after the X-Ray machine 140 has completed inspection of the object 160B from the X-Ray machine 140.

At step 1012, the trailing edge 163B of the object 160B arriving on the exit conveyor 122 can be sensed at a specific location by the one or more sensors 130B of the exit conveyor after the object 160B has passed the specific location on the exit conveyor belt 122. The computing system 150 can include instructions to sense the trailing edge 163B of the object 160B arriving on the exit conveyor 122. The computing system 150 can, in a manner identical to the entry conveyor 120 as described above, sense the trailing edge 163B of the object 160B based on the signal sensed by the sensor 130B. In some embodiments, the sensors at position 103B can be a multiple sets of PEC detectors, or sensors or both to ensure various sizes of objects can be successfully sensed. In some embodiments, the leading edge of the object 160B arriving on the exit conveyor 122 can be sensed at a specific location by one or more sensors 130B of the exit conveyor after the object 160B has passed the specific location on the exit conveyor belt 122.

At step 1014, upon sensing the trailing edge 163B of the object 160B, the raise flight solenoid 137A can be activated by the computing system 150 to translate the transfer bar 154B via the transfer rod 159 which is linked to the guide vane 177. The guide vane 177 along with the transfer bar 154B can be called a transfer gear. This activation aligns the cam or multiple cams 141, which are embedded within the flight 138 to engage with a gentle slope on the graded track 173. This wear strip has the effect of rotating the cam 141, which in turn raises the flight behind the trailing edge 163B of the object 160B. In some embodiments, upon sensing the leading edge of the object 160B, the raise flight solenoid 137A can be activated by the computing system 150.

At step 1016, the smart conveyor system informs the external material handling system 190B (shown in FIG. 1) of the presence of an object at the exit conveyor system 122, which is requesting entry to the external material handling system conveyor 190B. This transfer of the object to the external material handling system conveyor system 190B is undertaken via a series of volt free contact signals or in some embodiments via a communication protocol that could involve cabling or wireless communications. Information from the smart conveyor system to the Material Handling system can consist of; System Healthy, System running, and object available for exit signals. Information from the Material Handling System to the smart conveyor system can consist of; System Healthy, System running, and space available for exit signals.

At step 1018, upon transfer of the object from the exit conveyor to the external material handling system conveyor 190B any flights that may be in the raised position are folded down by virtue of coming off of the wear strips and falling down on their own gravity. These flights are folded back up on the underside of the conveyor by virtue of a set of guide rails prior to returning to the start position at the entry to the conveyor.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps can be replaced with a single element, component, or step. Likewise, a single element, component, or step can be replaced with a plurality of elements, components, or steps that serve the same purpose. Moreover, while exemplary embodiments have been shown and described with references to particular embodiments thereof, those of ordinary skill in the art will understand that various substitutions and alterations in form and detail can be made therein without departing from the scope of the present disclosure. Further, still, other aspects, functions, and advantages are also within the scope of the present disclosure.

Exemplary flowcharts are provided herein for illustrative purposes and are non-limiting examples of methods. One of ordinary skill in the art will recognize that exemplary methods can include more or fewer steps than those illustrated in the exemplary flowcharts and that the steps in the exemplary flowcharts can be performed in a different order than the order shown in the illustrative flowcharts.

1. A conveyor comprising:
a conveyor belt having a flight, the flight configured to be selectively positioned in a default position in which the flight is parallel to the conveyor belt and a raised position in which the flight is perpendicular to the conveyor belt; and
one or more sensors for sensing an edge of an object on the conveyor belt, wherein the flight is selectively transitioned to the raised position from the default position on the conveyor belt behind the object to assist the object forward.

2. The conveyor of claim 1, further comprising:
a plurality of cams on the flight;
a wear strip under the conveyor belt to engage with at least one cam in the plurality of cams when each flight is raised; and
a plurality of channels running along the length of the conveyor belt in the direction of travel of the conveyor belt to allow the plurality of cams to travel unhindered when the flight remains in the default position.

3. The conveyor of claim 2, further comprising;
a transfer bar disposed laterally perpendicular to the direction of travel of the conveyor belt and positioned below the conveyor belt, the transfer bar coupled to a solenoid which operates to move the flight laterally perpendicular to the conveyor belt, the transfer bar translates a transfer rod and guide vane between an engaged position and a disengaged position to align at least one cam on the flight with the wear strip when the transfer bar is in the engaged position or to align at least one cam with a channel running along the length of the conveyor belt in the direction of travel of the conveyor belt when the transfer bar is in the disengaged position.

4. The conveyor of claim 3, wherein the edge of the object is a leading edge or a trailing edge, and the conveyor further comprises:
a computing system including one or more processors communicatively coupled to the sensors and solenoids and configured to execute instructions to:
sense the edge of the object on the conveyor belt at a specific location on the conveyor belt when the one or more sensors sense the object has passed the specific location on the conveyor belt; and
upon sensing the edge of the object, activate the solenoid to move the transfer bar to translate the guide vane to align at least one cam with the wear strip on the conveyor to allow the at least one cam to slide on a graded track that rotates the flight perpendicular to the surface of the conveyor belt behind the edge of the object.

5. The conveyor of claim 1, wherein the flight includes a cam, and the conveyor further comprises:
a solenoid coupled to a transfer bar located below the conveyor belt with a transfer rod to translate a transfer gear with a guide vane to align with a wear strip located below the conveyor belt;
a computing system including one or more processors configured to execute instructions to:
sense the edge of the object on the conveyor belt at a specific location on the conveyor belt based on an output of the one or more sensors; and
upon sensing the edge of the object, activate the solenoid to move the transfer bar to translate the transfer rod and guide vane to align with the wear strip on the conveyor belt to allow the cam on the flight to slide on a graded track that rotates the flight perpendicular to the surface of the conveyor belt behind object.

6. The conveyor of claim 5, wherein the cam engages with the wear strip frictionally when the flight has been raised.

7. The conveyor of claim 5, wherein the cam is guided by the guide vane onto the wear strip.

8. The conveyor of claim 5, wherein the one or more sensors are at least one of an optical sensor or an acoustic sensor.

9. The conveyor of claim 5, wherein the conveyor belt includes a plurality of flights, and a pitch between the plurality of flights is set at approximately fifty millimeters.

10. The conveyor of claim 5, wherein the computing system is further configured to execute instructions to:
sense an object-ID associated with the object;
determine whether the object has been transferred to an X-Ray machine through one or more lead curtains on the conveyor; and
upon a determination that the object has been transferred to the X-Ray machine communicate the object-ID associated with the object to the X-Ray machine.

11. A system comprising:
an entry conveyor configured to transfer an object to an X-Ray machine and an exit conveyor configured to receive the object from the X-Ray machine, at least one of the entry conveyor or the exit conveyor including:
a conveyor belt having a flight, the flight configured to be selectively positioned in a default position in which the flight is parallel to the conveyor belt and a raised position in which the flight is perpendicular to the conveyor belt; and
one or more sensors for sensing an edge of an object on the conveyor belt, wherein the flight is selectively transitioned to the raised position from the default position on the conveyor belt behind the object to assist the object forward.

12. The system of claim 11, wherein at least one of the entry conveyor or the exit conveyor further comprises
a solenoid coupled to a transfer arm located below the conveyor belt with attached cams to translate a transfer arm to align the cams with wear strips located below the conveyor belt;
a computing system including one or more processors configured to execute instructions to:
sense the edge of the object on the conveyor belt at a specific location on the conveyor belt based on an output of the one or more sensors of the entry conveyor; and
upon sensing the edge of the object, activate the solenoid to move the transfer arm in a direction substantially perpendicular to the direction of travel of an entry conveyor belt to translate a transfer rod and guide vane to align with the wear strip on the conveyor to allow one of a plurality of cams on one of a plurality of flights to slide on a graded track that rotates the flight perpendicular to the surface of the conveyor belt behind the edge of the object.

13. The system of claim 12, wherein the one or more processors are configured to:
sense an object-ID associated with the object;
communicate the object-ID associated with the object to the X-Ray machine;
receive the object-ID associated with the object and an indication of whether the object has passed an X-Ray inspection;
sense the edge of the object arriving on the conveyor belt of the exit conveyor at a specific location on the conveyor belt of the exit conveyor based on an output of the one or more sensors of the exit conveyor; and
upon sensing the edge of the object, the flight of exit conveyor is selectively transitioned to the raised position from the default position on the conveyor belt of the exit conveyor behind the object to assist the object forward.

14. The system of claim 13, wherein the computing system is further configured to execute instructions to:
receive the object-ID associated with the object and an indication of whether the object has passed the X-Ray inspection; and
upon receipt of information relative to the object, forward the information onto a receiving material handling system.

15. The system of claim 13, wherein the cam engages with the wear strip frictionally when the flight is in a raised position.

16. The system of claim 13, wherein the flight further comprises the cam that engages with a corresponding wear strip positioned under the conveyor belt when the flight is raised locks the flight perpendicular to the plane of the conveyor belt.

17. The system of claim 13, wherein the conveyor belt is configured to include a plurality of flights, and a pitch between the plurality of flights can be configured at varying distances.

18. The system of claim 13, wherein the transfer arm translates the cam engaged in the guide vane to translate the flight and align another cam with a second wear strip under the conveyor belt.

19. A method for object handling, comprising:
sensing an edge of an object arriving on a conveyor belt at a specific location on the conveyor belt by one or more sensors in response to the edge of the object passing the specific location on the conveyor belt; and
upon sensing of the edge of the object, selectively transitioning a flight on the conveyor belt to a raised position from a default position on the conveyor belt behind the object to assist the object forward.

20. The method of claim 19, wherein selectively transitioning the flight on the conveyor to the raised position comprises:
activating a solenoid to move a transfer bar to translate a transfer rod and guide vane to align with a wear strip positioned under the conveyor belt to allow a cam on the to slide on a graded track that has an effect of rotating the flight perpendicular to a surface of the conveyor belt behind the object,
wherein the cam engages with the wear strip frictionally when the flight is in the raised position to lock the flight in a raised position perpendicular to the plane of the conveyor belt.

21. The method of claim 19, further comprising
sensing an object-ID associated with the object;
communicating the object-ID associated with the object to an X-Ray machine disposed proximate to the conveyor belt; and
receiving the object-ID associated with the object and an indication of whether the object has passed or not passed an X-Ray inspection,
wherein upon a determination that the object has not passed the X-Ray inspection the object that has not passed the X-Ray inspection is flagged for rescreening.

22. The method of claim 19, wherein the one or more sensors are at least one of optical sensors and acoustic sensors.

23. The method of claim 19, wherein conveyor belt can include a plurality of independently controllable flights, and a pitch between the plurality of independently controllable flights can be configured at varying distances.
